(19) United States
(12) Patent Application Publication
(10) Pub. No.: US 2025/0321463 A1
(43) Pub. Date: Oct. 16, 2025

(54) WAVELENGTH CONVERTING DEVICE AND WAVELENGTH CONVERTING METHOD

(71) Applicant: Fujitsu Limited, Kawasaki-shi (JP)

(72) Inventor: Tomoyuki KATO, Yokohama (JP)

(73) Assignee: Fujitsu Limited, Kawasaki-shi (JP)

(21) Appl. No.: 19/063,500

(22) Filed: Feb. 26, 2025

(30) Foreign Application Priority Data
Apr. 12, 2024 (JP) 2024-064933

(51) Int. Cl. G02F 1/37; G02F 1/355; G02F 1/365

(52) U.S. Cl. CPC G02F 1/37; G02F 1/3551; G02F 1/3558; G02F 1/365; G02F 2202/20

(57) ABSTRACT

A wavelength converting device includes: an optical power monitor that monitors fluctuation of optical power of signal light input to the wavelength converting device; a pump light source that outputs pump light; an optical modulator that performs intensity modulation which includes modulating an intensity of the pump light output by the pump light source; a multiplexer that multiplexes the intensity-modulated pump light and the signal light; a nonlinear optical medium that, using a nonlinear optical effect, generates wavelength converted light of the signal light output by the multiplexer; and a controller configured to vary and output to the optical modulator, optical power of the pump light of the pump light source, the controller varying the optical power of the pump light based on the fluctuation detected by the optical power monitor.

### CROSS REFERENCE TO RELATED APPLICATIONS

This application is based upon and claims the benefit of priority of the prior Japanese Patent Application No. 2024-064933, filed on Apr. 12, 2024, the entire contents of which are incorporated herein by reference.

### FIELD OF THE INVENTION

The embodiments discussed herein relate to a wavelength converting device and a wavelength converting method.

### BACKGROUND OF THE INVENTION

In response to ever-increasing traffic in optical networks, multi-band transmission technology is being introduced to increase the number of wavelength multiplexing channels and expand transmission capacity. Research is focused on developing wavelength conversion technology to support multi-band transmission. For example, transmission bandwidth may be expanded by using optical transceivers developed for existing bands, while transmitting in a new wavelength band on the transmission path. When the optical power input to a wavelength converter provided in an optical transceiver is excessive or insufficient, the signal will become distorted or linear noise will increase.

Prior art techniques include, for example, a technique that, according to the measurements of the power of signal light input to a Raman amplification medium, controls a ratio of gain generated by forward pump light and gain generated by backward pump light to suppress degradation caused by additional nonlinear waveform distortion occurring in forward pumping. Further, there is a technology that uses an optical amplifier to monitor input signals and other system characteristics, including optical pumping and has components that compensate for scattering. Further, there is a technology in which input light is received by a monitoring photodiode and a controller generates a signal necessary to stabilize a current source according to power measurements of input and output amplifiers and thereby reduces amplified spontaneous emission (ASE) and improves the signal-to-noise ratio (SNR) of an amplifier system. Further, there is a technique of detecting the intensity of noise of a different frequency in multiplexed light by a receiver and using an error signal to adjust driving current characteristics of a pump laser to reduce the error signal. For example, refer to Japanese Laid-Open Patent Publication No. 2003-131273, Japanese Laid-Open Patent Publication No. 2016-164664, U.S. Patent Application, Publication No. 2004/0017603, and U.S. Patent Application, Publication No. 2004/0253001.

### SUMMARY OF THE INVENTION

According to an aspect of an embodiment, a wavelength converting device includes: an optical power monitor that monitors fluctuation of optical power of signal light input to the wavelength converting device; a pump light source that outputs pump light; an optical modulator that performs intensity modulation which includes modulating an intensity of the pump light output by the pump light source; a multiplexer that multiplexes the intensity-modulated pump light and the signal light; a nonlinear optical medium that, using a nonlinear optical effect, generates wavelength converted light of the signal light output by the multiplexer; and a controller configured to vary and output to the optical modulator, optical power of the pump light of the pump light source, the controller varying the optical power of the pump light based on the fluctuation detected by the optical power monitor.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a summary diagram of a first example of a wavelength converting device.

FIG. 2 is a summary diagram of a second example of the wavelength converting device.

FIG. 3 is a flowchart depicting an outline of control of the wavelength converting device.

FIG. 4 is a diagram depicting a first configuration example of a multi-band transmission system.

FIG. 5 is a diagram depicting a second configuration example of the multi-band transmission system.

FIG. 6 is a diagram depicting an example of configuration of a wavelength converting device according to a conventional technique.

FIG. 7A is an explanatory diagram of an occurrence of nonlinear distortion due to saturation of the conversion efficiency.

FIG. 7B is an explanatory diagram of an occurrence of nonlinear distortion due to saturation of the conversion efficiency.

FIG. 8AA is a graph depicting the amount of nonlinear distortion that occurs due to saturation of the conversion efficiency by conventional techniques.

FIG. 8AB is a graph depicting the amount of nonlinear distortion that occurs due to saturation of the conversion efficiency by the conventional techniques.

FIG. 8AC is a graph depicting the amount of nonlinear distortion that occurs due to saturation of the conversion efficiency by the conventional techniques.

FIG. 8AD is a graph depicting the amount of nonlinear distortion that occurs due to saturation of the conversion efficiency by the conventional techniques.

FIG. 8BA is a graph depicting the amount of nonlinear distortion occurring due to saturation of the conversion efficiency by the embodiments.

FIG. 8BB is a graph depicting the amount of nonlinear distortion occurring due to saturation of the conversion efficiency by the embodiments.

FIG. 8BC is a graph depicting the amount of nonlinear distortion occurring due to saturation of the conversion efficiency by the embodiments.

FIG. 8BD is a graph depicting the amount of nonlinear distortion occurring due to saturation of the conversion efficiency by the embodiments.

FIG. 9A is a graph depicting an example of degradation of characteristics with the conventional techniques.

FIG. 9B is a graph depicting an example of degradation of characteristics with the conventional techniques.

FIG. 10 is a diagram of a third example of the wavelength converting device.

FIG. 11 is a diagram of a fourth example of the wavelength converting device.

FIG. 12 is a diagram depicting an example of a hardware configuration of a controller of the wavelength converting device.

FIG. 13 is a flowchart depicting detailed control of the wavelength converting device.

### DESCRIPTION OF THE INVENTION

First, problems associated with the conventional techniques are discussed. When high optical power is input to a wavelength converter, conversion efficiency is saturated and the converted signal becomes distorted, whereby with conventional techniques, the input power to the wavelength converter is limited to avoid this nonlinear distortion. However, when the input optical power is limited, linear noise occurring at a downstream optical amplifier increases.

While described in detail hereinafter, an occurrence of nonlinear distortion may be avoided by reducing the power input to the wavelength converter and using a downstream optical pump to compensate the amount of the input power that is reduced, however, the amount of linear noise generated by the optical pump increases. As a result, with the conventional techniques, nonlinear noise or linear noise increases and signal quality degrades.

Further, in multi-band transmission that uses a wavelength converter of a conventional technology, even when the number of wavelength multiplexing channels is simply increased, the bandwidth is limited by the optical transceivers and optical amplifiers, and it is necessary to newly develop optical transceivers and optical amplifiers to accommodate the increased bandwidth. Further, conversion efficiency of wavelength conversion is limited by the characteristics of the nonlinear optical medium and achieving both increases in efficiency and suppression of nonlinear noise is difficult.

Embodiments of a wavelength converting device and a wavelength converting method of the present disclosure are described in detail with reference to the accompanying drawings. For example, the wavelength converting device is provided in an optical transmitting device of a wavelength division multiplexing (WDM) optical transmission system; the wavelength converting device multiplexes signal light that has been wavelength-converted and output from an optical transmitter; the wavelength converting device outputs the multiplexed signal light to a transmission path, thereby, transmitting the light to an optical receiving device. Further, for example, the wavelength converting device is provided in an optical receiving device of an optical transmission system and generates/extracts signal light that has been wavelength-converted corresponding to an optical receiver.

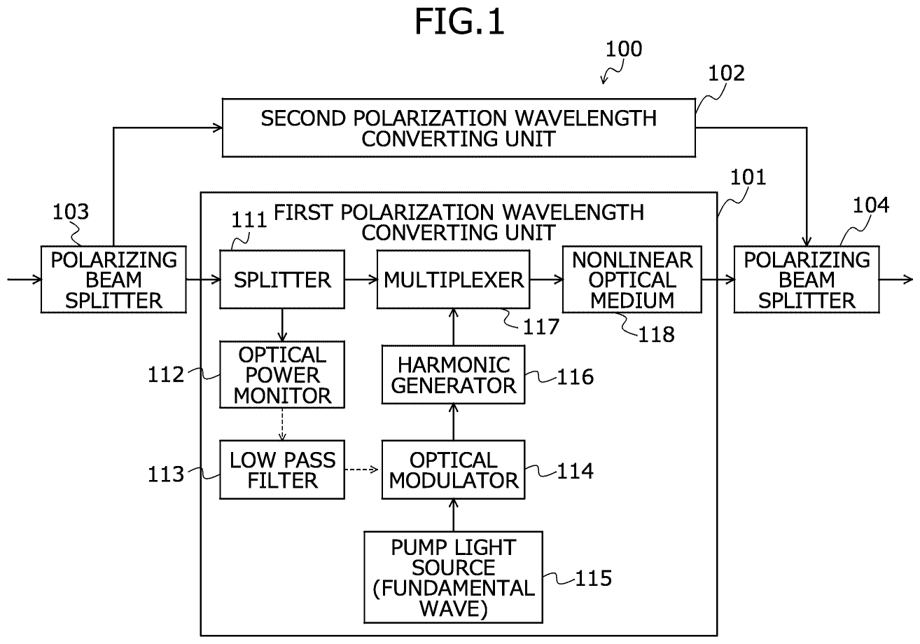

FIG. 1 is a summary diagram of a first example of a wavelength converting device. When modulating the intensity of fundamental-wave pump light input to a second-order nonlinear optical medium based on the intensity of the noise of input signal light, a wavelength converting device 100 of the first example compensates nonlinear distortion that occurs due to saturation of the conversion efficiency. FIG. 1 is an example of a configuration of the wavelength converting device 100 provided in the optical transmitting device, the wavelength converting device 100 having a first polarization wavelength converting unit 101, a second polarization wavelength converting unit 102, a polarizing beam splitter 103, and a polarizing beam splitter 104. In FIG. 1 and subsequent drawings, a solid line indicates a path of signal light while a dotted line indicates an electrical signal path. In the summary diagram depicted in FIG. 1, while a controller (control unit) that controls the device is not depicted, as described hereinafter, the controller (control unit) controls wavelength- conversion.

The polarizing beam splitter 103 separates input signal light that has been polarization multiplexed, outputs one polarization component of the input signal light to the first polarization wavelength converting unit 101, and outputs the other polarization component of the input signal light to the second polarization wavelength converting unit 102.

The first polarization wavelength converting unit 101 has a splitter 111, an optical power monitor 112, a low pass filter 113, an optical modulator 114, a pump light source 115, a harmonic generator 116, a multiplexer 117, and a nonlinear optical medium 118.

The splitter 111 splits and outputs the input signal light to the optical power monitor 112 and the multiplexer 117. The optical power monitor 112 monitors the optical power of the input signal light. The low pass filter 113 outputs a low-frequency component of the detected input signal light to the optical modulator 114, the low-frequency component having a modulation frequency (low-speed component whose optical power varies over time).

The optical modulator 114 modulates, based on fluctuation of the optical power of the input signal light, the intensity of pump light of a fundamental wave (for example, communication wavelength 1550 nm) output by the pump light source 115. The harmonic generator 116 generates harmonics, for example, second-order harmonic pump light, obtained by multiplying the fundamental wave. A frequency band of the intensity modulation output by the optical modulator 114 is limited to be lower than a modulation rate of the input signal light.

The multiplexer 117 multiplexes the input signal light and the optically modulated pump light and inputs the resulting multiplexed light to the nonlinear optical medium 118. The nonlinear optical medium 118 is an optical medium (second-order nonlinear optical medium) having a nonlinear optical effect and generates wavelength converted light (also referred to as converted light, idler light), which is the input signal light that has been wavelength-converted through a nonlinear optical effect and Raman amplification.

An optical fiber, planar optical waveguide, or the like may be used as the nonlinear optical medium 118. In an instance of an optical fiber, pump light and signal light are combined and input and thus, a device is used that generates wavelength converted light having a different wavelength from the signal light by differential frequency generation (or four wave mixing) through second-order (or third-order) nonlinear polarization. For example, an optical fiber with a small core cross-sectional area or a highly nonlinear fiber containing a dopant with a high nonlinear refractive index may be used.

In an instance of a planar optical waveguide, a planar optical waveguide with a core made of a dielectric material with a high specific refractive index difference or nonlinear refractive index, for example, silicon or a compound semiconductor, may be used. Further, for example, a planar optical waveguide using an optical crystal such as periodically poled lithium niobate with a large second-order nonlinear polarization may be used.

While not depicted in FIG. 1, the second polarization wavelength converting unit 102 has an internal configuration similar to that of the first polarization wavelength converting unit 101 (the splitter 111 to the nonlinear optical medium 118) and generates wavelength converted light for the other polarization component of the input signal light.

The polarizing beam splitter 104 outputs wavelength converted light in which the polarization component of the first polarization wavelength converting unit 101 and the polarization component of the second polarization wavelength converting unit 102 are combined.

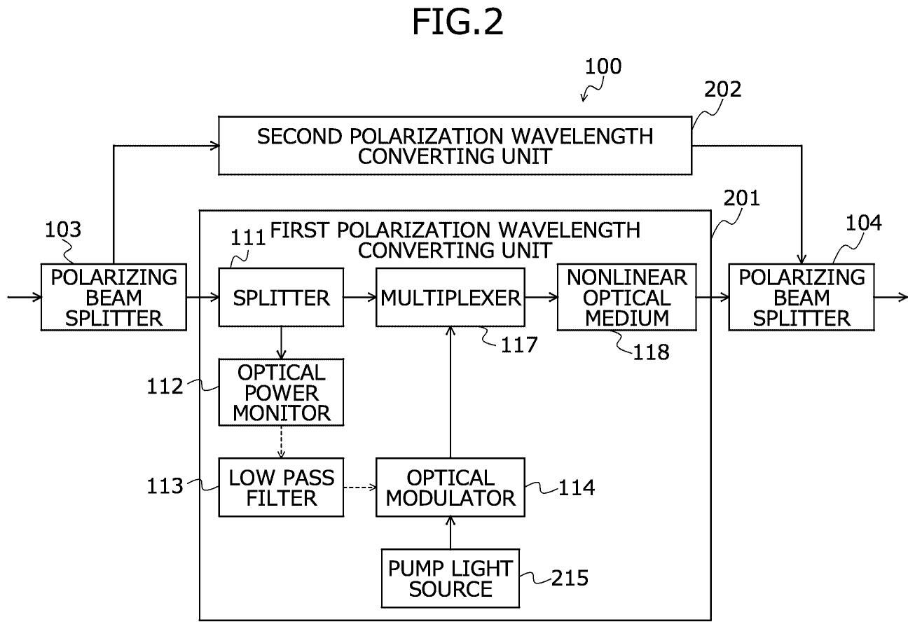

FIG. 2 is a summary diagram of a second example of the wavelength converting device. The wavelength converting device 100 of the second example has a pump light source of a type different from the type of the pump light source of the first example. In the second example, when second harmonic pump light input to the second-order nonlinear optical medium or pump light input to a third-order nonlinear optical medium is intensity-modulated based on the intensity of the noise in the input signal light, nonlinear distortion occurring due to saturation of the conversion efficiency is compensated. In the second example depicted in FIG. 2, components that are the same as those of the first example depicted in FIG. 1 are given the same reference numerals used in the first example.

The wavelength converting device 100 depicted in FIG. 2 includes a first polarization wavelength converting unit 201, a second polarization wavelength converting unit 202, the polarizing beam splitter 103, and the polarizing beam splitter 104.

The first polarization wavelength converting unit 201 includes the splitter 111, the optical power monitor 112, the low pass filter 113, the optical modulator 114, the pump light source 215, the multiplexer 117, and the nonlinear optical medium 118.

In the configuration example depicted in FIG. 2, a pump light source 215 outputs a second-harmonic pump light (for example, 780 nm) of a fundamental wave and the harmonic generator 116 is omitted. Further, the nonlinear optical medium 118 is a second-order nonlinear optical medium. Further, the pump light source 215 may be a fundamental-wave pump light source and the nonlinear optical medium 118 may be a third-order nonlinear optical medium.

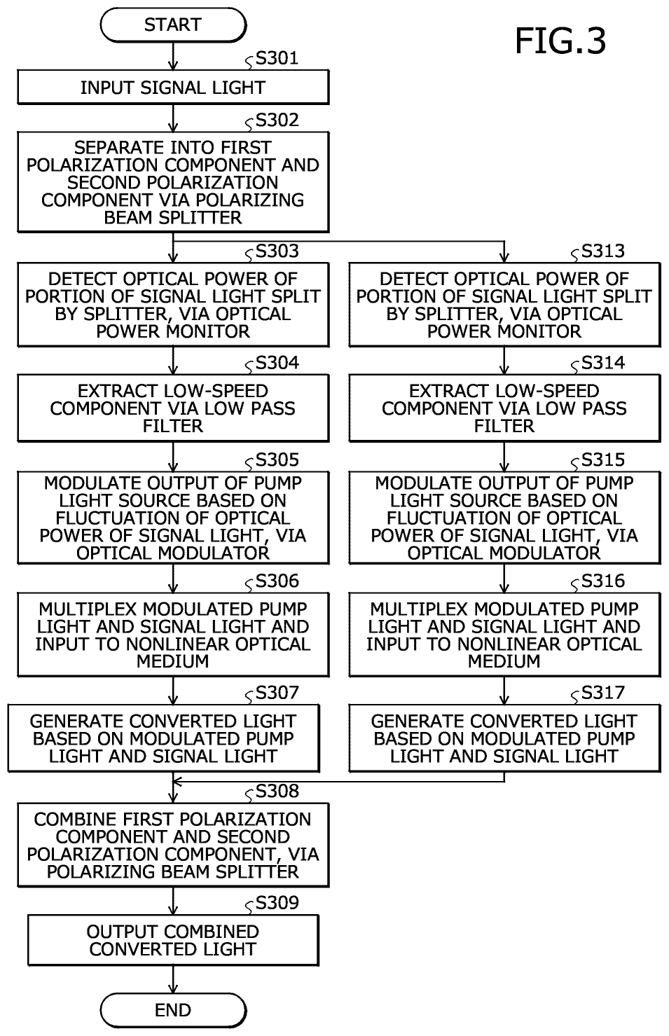

FIG. 3 is a flowchart depicting an outline of control of the wavelength converting device. A control example depicted in FIG. 3 is common to the first and second examples. Herein, the control example is described with respect to the wavelength converting device 100 of the first example. Signal light is input to the wavelength converting device 100 (step S301). The polarizing beam splitter 103 separates the input signal light into a first polarization component and a second polarization component (step S302).

The first polarization component is output to the first polarization wavelength converting unit 101, which executes the control at steps S303 to S307. First, the optical power monitor 112 detects the optical power of the signal light split by the splitter 111 (step S303). Next, the low pass filter 113 extracts a low-speed component of the signal light (step S304).

Next, the optical modulator 114 modulates the output of the pump light source 115 based on fluctuation of the optical power of the signal light (step S305). For example, the optical modulator 114 performs intensity modulation on the pump light corresponding to the fluctuation of the optical power of the input signal light. Next, the multiplexer 117 multiplexes the modulated pump light and the signal light and inputs the resulting light to the nonlinear optical medium 118 (step S306). The nonlinear optical medium 118 generates converted light based on the modulated pump light and the signal light (step S307).

Further, the second polarization component is output to the second polarization wavelength converting unit 102 and is subjected to the control at steps S313 to S317. The control executed by the second polarization wavelength converting unit 102 at steps S313 to S317 is the same control executed by the first polarization wavelength converting unit 101 at steps S303 to S307.

Further, the converted light of the first polarization component output by the first polarization wavelength converting unit 101 at step S307 and the converted light of the second polarization component output by the second polarization wavelength converting unit 102 at step S317 are output to the polarizing beam splitter 104. The polarizing beam splitter 104 combines the first polarization component and the second polarization component (step S308). Subsequently, the wavelength converting device 100 outputs the combined converted light (step S309). Details of the control in an example of the control of the wavelength converting device 100 of the second example are the same as those depicted in FIG. 3.

In the wavelength converting device of the embodiments, intensity modulation of the pump light output is controlled based on the fluctuation of the optical power of the input signal light. For example, the optical power of the pump light input is controlled to fluctuate (increase or decrease) in the same way as the fluctuation of the optical power of the input signal light (increase or decrease). As a result, response to fluctuations in the optical power of the input signal light is possible and by keeping the power of the pump light output nearly constant, saturation of the conversion efficiency is suppressed and nonlinear noise (and linear noise) and degradation of signal quality are reduced.

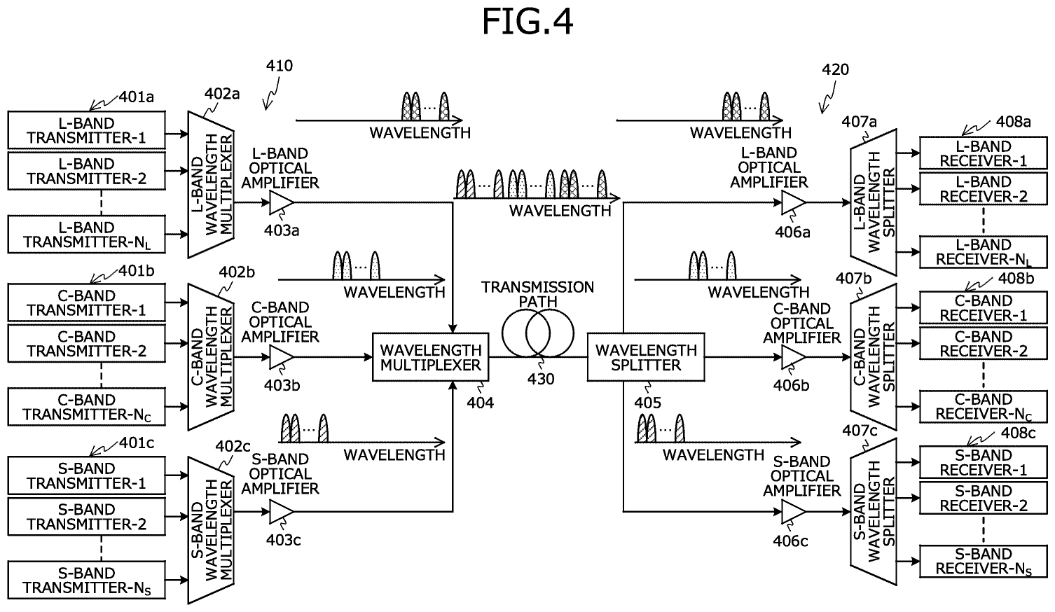

FIG. 4 is a diagram depicting a first configuration example of a multi-band transmission system. Here, an example of the configuration of the multi-band transmission system, which increases the number of wavelength multiplexing channels to expand the transmission capacity, is described. In the example of the configuration of the system in FIG. 4, a transmitting device 410 and a receiving device 420 transmit signal light in three different wavelength bands, for example, the L-band, C-band, and S-band of WDM.

The transmitting device 410 includes L-band transmitters 401a, C-band transmitters 401b, S-band transmitters 401c, an L-band wavelength multiplexer 402a, a C-band wavelength multiplexer 402b, and an S-band wavelength multiplexer 402c. The transmitting device 410 further includes an L-band optical amplifier 403a, a C-band optical amplifier 403b, an S-band optical amplifier 403c, and a wavelength multiplexer 404. The wavelength multiplexer 404 outputs signal light of each of the bands, the L-band, the C-band, and the S-band, to a transmission path 430.

The receiving device 420 includes a wavelength splitter 405, an L-band optical amplifier 406a, a C-band optical amplifier 406b, and an S-band optical amplifier 406c. The receiving device 420 further includes an L-band wavelength splitter 407a, a C-band wavelength splitter 407b, an S-band wavelength splitter 407c, L-band receivers 408a, C-band receivers 408b, and S-band receivers 408c. The optical receivers 408 convert input signal light into electrical signals and output the electrical signals.

In the multi-band system depicted in FIG. 4, the bandwidth is limited by the optical transmitters 401, the optical receivers 408, the optical amplifiers 403, 406, etc. for each band. In order to wavelength-multiplex more channels than the limited number of channels of these individual bands, it becomes necessary to use optical components such as optical transceivers and optical amplifiers of additional bands, which increases costs.

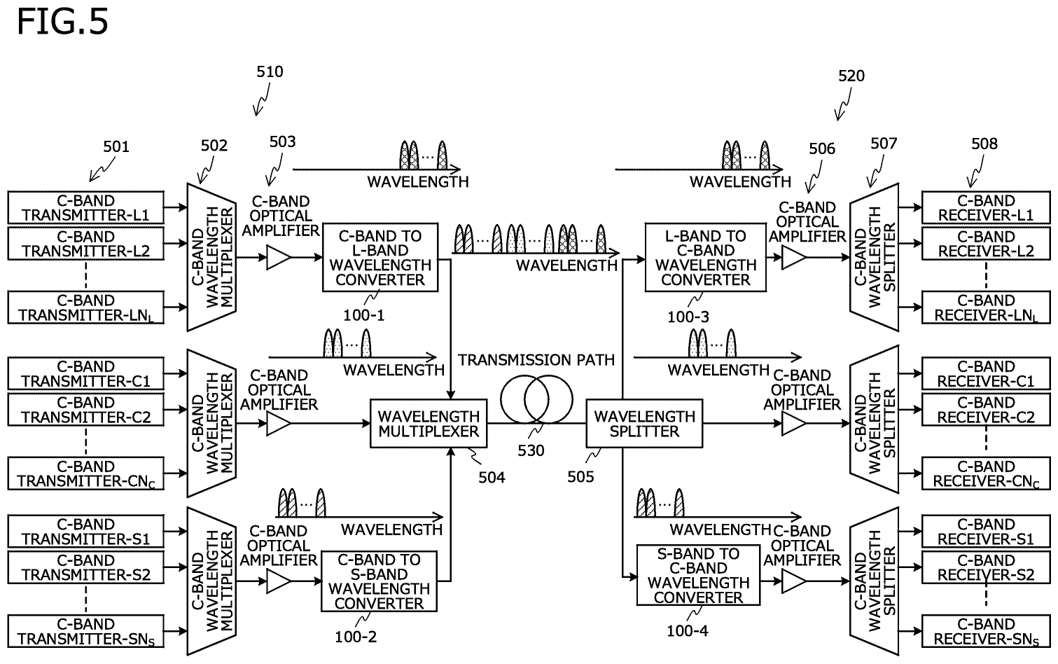

FIG. 5 is a diagram depicting a second configuration example of the multi-band transmission system. FIG. 5 depicts an example in which the wavelength converting device 100 of the first and second examples (FIG. 1, FIG. 2) described above is applied to the multi-band transmission system. The wavelength converting device 100 is disposed in both a transmitting device 510 and a receiving device 520, and signal light is transmitted through a transmission path 530.

In the example depicted in FIG. 5, the transmitting device 510 and the receiving device 520 transmit signal light in three different wavelength bands, for example, the L-band, C-band, and S-band of WDM. The transmitting device 510 includes C-band transmitters 501, C-band wavelength multiplexers 502, C-band optical amplifiers 503, and a wavelength multiplexer 504. The transmitters 501 convert input electrical signals into signal light of the C-band wavelength (first wavelength band) and output the signal light.

The transmitting device 510 has a wavelength converting device 100-1 that converts the C-band signal light into L-band (second wavelength band) signal light and a wavelength converting device 100-2 that converts the C-band signal light into S-band (third wavelength band) signal light.

The receiving device 520 includes a wavelength splitter 505, C-band optical amplifiers 506, C-band wavelength splitters 507, and C-band receivers 508. The receivers 508 convert the input signal light of the C-band wavelength into electrical signals and output the electrical signals.

The receiving device 520 has a wavelength converting device 100-3 that converts L-band signal light into C-band signal light and a wavelength converting device 100-4 that converts S-band signal light into C-band signal light.

The wavelength converting devices 100-1 and 100-2 provided in the transmitting device 510 may be applied as is to the configuration described in the first example (FIG. 1) or the second example (FIG. 2). The wavelength converting devices 100-3, 100-4 provided in the receiving device 520 may be applied as is to the configuration described in the first example (FIG. 1) or the second example (FIG. 2).

According to the multi-band transmission system, the transmitting device 510 and the receiving device 520 may use the transmitters 501 and the receivers 508 to increase the number of WDM wavelength multiplexed channels and expand transmission capacity. Further, the wavelength converting devices 100 (100-1 to 100-4), which convert the wavelength of the signal light, are provided in both the transmitting device 510 and the receiving device 520.

As a result, the transmitters 501, the receivers 508, the optical amplifiers 503, 506, the wavelength multiplexers 502, and the wavelength splitters 507 of the transmitting device 510 and the receiving device 520 are configured economically by using optical components of a common wavelength band (C-band).

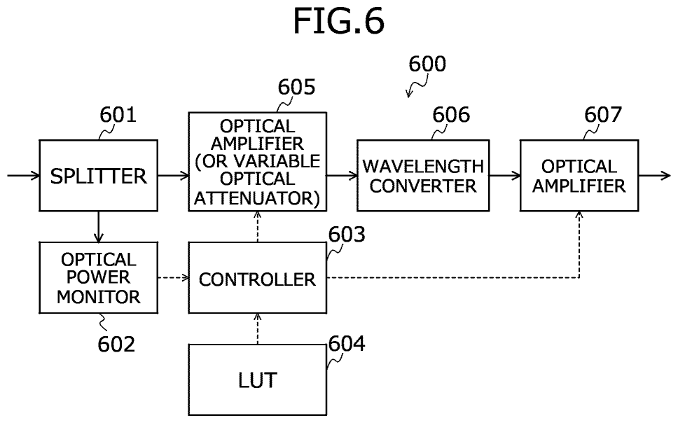

Problems associated with the conventional techniques are discussed. FIG. 6 is a diagram depicting an example of configuration of a wavelength converting device according to a conventional technique. A conventional wavelength converting device 600 includes a splitter 601, an optical power monitor 602, a controller 603, a look-up table (LUT) 604, an optical amplifier 605, a wavelength converter 606, and an optical amplifier 607. The optical amplifier 605 adjusts the input power to the wavelength converter 606, acting as a variable optical attenuator.

Input signal light is split by the splitter 601 and input to the optical power monitor 602 and the optical amplifier 605. The optical power monitor 602 monitors the optical power of the input signal light and outputs the optical power to the controller 603. The controller 603 adjusts the output power of the upstream optical amplifier 605, corresponding to the optical power of the input signal light set in the look-up table 604 that was pre-populated based on prior evaluations and the adjusted output power is input to the wavelength converter 606. The downstream optical amplifier 607 compensates the adjusted output optical power.

In FIG. 6, when the optical power of the input signal light to the wavelength converter 606 is sufficiently lower compared to the pump light power, optical power transition from the pump light to the signal light and idler light (wavelength converted light) is sufficiently lower. In this instance, nonlinear distortion added to the idler light generated as a phase conjugate of the input signal light may be disregarded.

On the other hand, when the power of the signal light input to the wavelength converter 606 is not a sufficiently low level compared to the pump light power, optical power transition of the pump light to the signal light and idler light increases and thus, the optical power of the pump light is attenuated and the conversion efficiency is saturated.

Instantaneous optical attenuation of the pump light is dependent on instantaneous optical power of the input signal light and thus, when the input signal light has an intensity modulation component, the conversion efficiency is instantaneously saturated and nonlinear distortion is added to the converted signal.

While the thresholds for occurrence are not the same because the quantitative values of the nonlinear polarizations are different, the above process occurs similarly for second-order nonlinearity and third-order nonlinearity. The amount of saturation of the conversion efficiency and the amount of nonlinear distortion are correlated. Thus, the input power and output power of the wavelength converter 606 are monitored and thus, while the amount of nonlinear distortion may be estimated, when the wavelength converter 606, whose input signal state changes and whose transmittance and conversion efficiency change over time, is operated in a saturation region, changes in the input signal state and changes in the wavelength converter characteristics over time cannot be separated. For example, in the control that uses the LUT 604, changes in the input signal state and changes in the wavelength converter characteristics over time cannot be responded to.

In the configuration depicted in FIG. 6, the input power to the wavelength converter 606 is reduced and while an occurrence of nonlinear distortion may be avoided by using the downstream optical amplifier 607 to compensate for the amount that the input power is reduced, the amount of linear noise generated by the optical amplifier 607 increases. As a result, in the conventional techniques, nonlinear noise or linear noise increases and signal quality degrades.

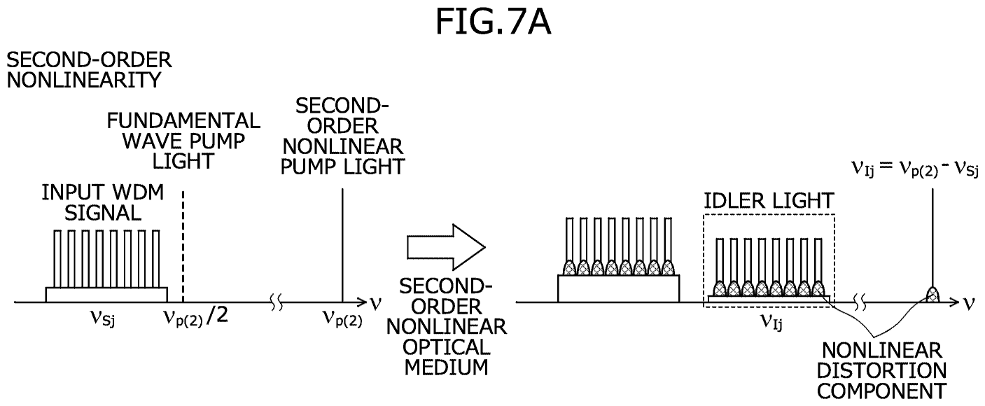

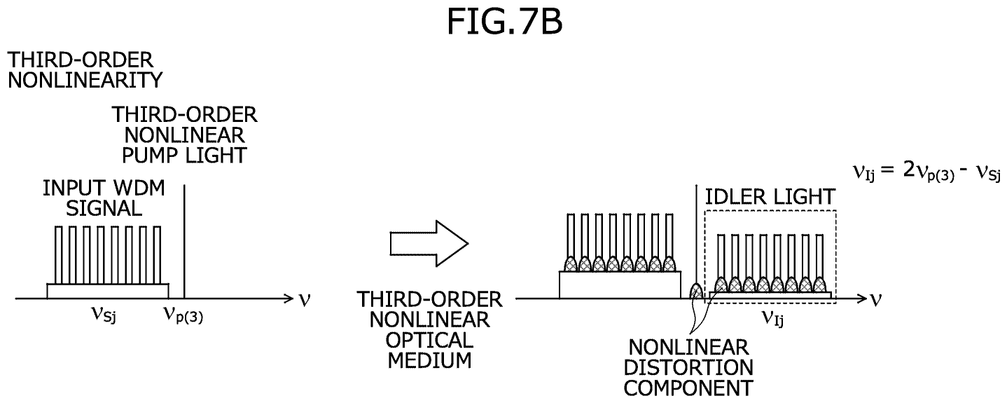

FIGS. 7A and 7B are explanatory diagrams of an occurrence of nonlinear distortion due to saturation of the conversion efficiency. FIG. 7A is an explanatory diagram of second-order nonlinearity. The input signal light (for example, 1550 nm WDM light, V_{Sj}) is free of nonlinear components. Second-order nonlinear pump light Vₚ₍₂₎ has a frequency (for example, 780 nm) that is two times that of the fundamental wave pump light. When the input signal light and the pump light are input to a second-order nonlinear medium, a nonlinear distortion component due to ASE light is added to each channel of the WDM signal and the generated idler light (wavelength converted light, V_{Ij}) and the SNR degrades.

FIG. 7B is an explanatory diagram of third-order nonlinearity. The input signal light (WDM light, V_{Sj}) is free of nonlinear components. When the input signal light and third-order nonlinear pump light Vₚ₍₃₎ are input to a third-order nonlinear medium, a nonlinear distortion component due to ASE light is added to each channel of the WDM signal and the generated idler light (wavelength conversion light, V_{Ij}), and the SNR deteriorates.

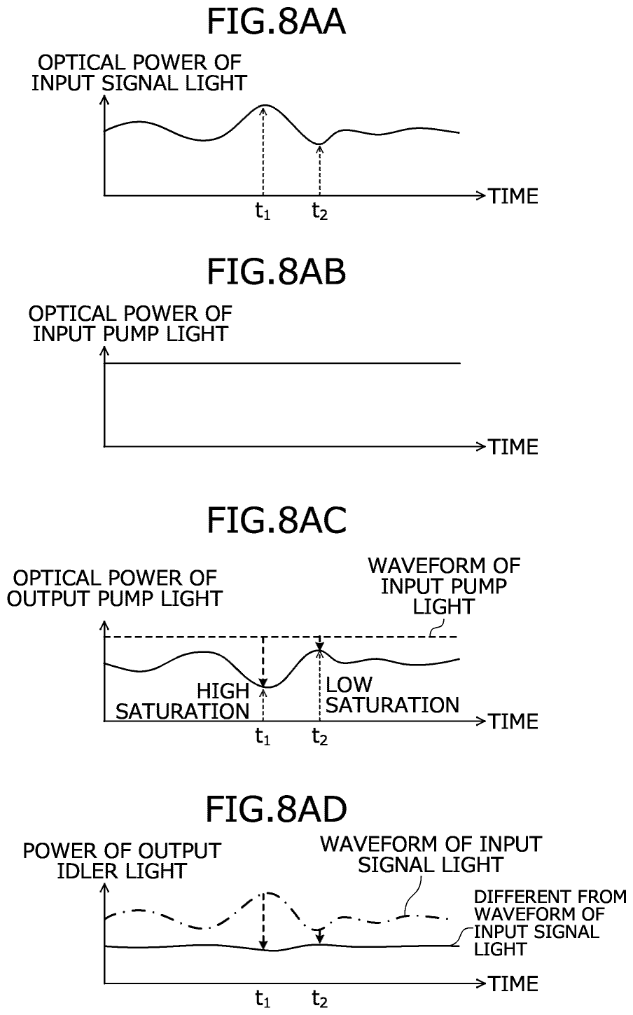

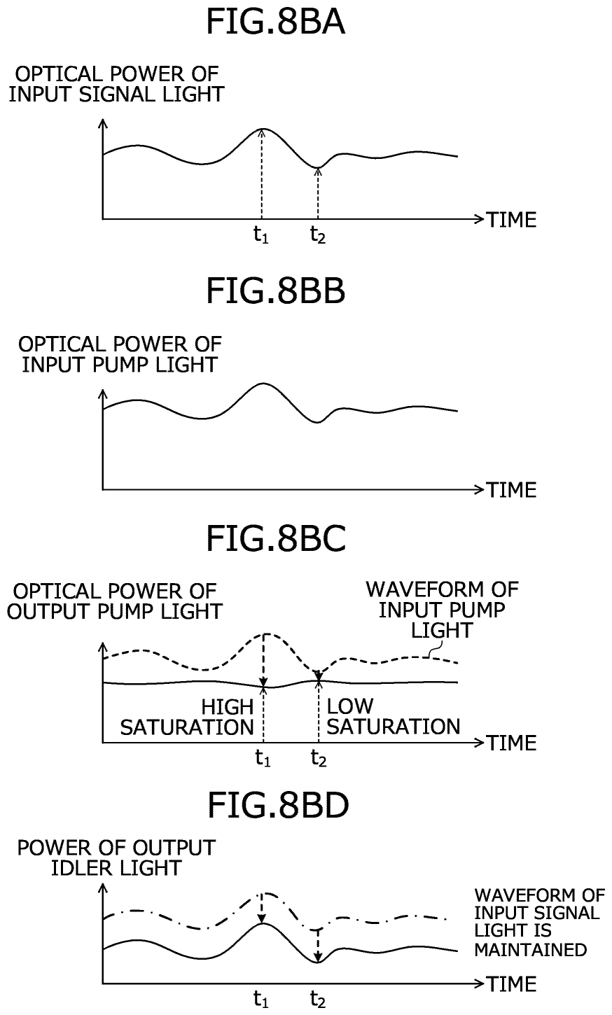

FIGS. 8AA, 8AB, 8AC, and 8AD are graphs depicting the amount of nonlinear distortion that occurs due to saturation of the conversion efficiency by the conventional techniques. The input optical power of the signal light in FIG. 8AA changes over time (periods t₁, t₂). In contrast, as depicted in FIG. 8AB, in the conventional techniques, the input optical power of the pump light is constant, regardless of changes in the input optical power of the signal light.

As a result, as depicted in FIG. 8AC, power of the output pump light decreases in period t₁ (high saturation) and increases in period t₂ (low saturation). Further, the power of the output idler light depicted in FIG. 8AD exhibits a waveform that is different from the waveform of the input signal light depicted in FIG. 8AA. The power of the output idler light depicted in FIG. 8AD exhibits an output waveform in which the change is small compared to the waveform of the input signal light.

FIGS. 8BA, 8BB, 8BC, and 8BD are graphs depicting the amount of nonlinear distortion occurring due to saturation of the conversion efficiency by the embodiments. The optical power of the input signal light in FIG. 8BA changes over time (periods t₁, t₂). In the embodiments, as depicted in FIG. 8BB, the optical power of the input pump light is changed in a same direction that the optical power of the input signal light changes. The average value of the optical power of the input pump light over time is nearly a same as that conventionally (nearly the same as the constant input optical power of the pump light shown in FIG. 8AB). The pump light corresponds to the low-frequency component of the input signal light extracted by the low pass filter 113 and is intensity-modulated by the modulator 114, with the frequency band of the intensity modulation being limited to be lower than the modulation rate of the input signal light.

As a result, as depicted in FIG. 8BC, power of the output pump light remains nearly constant, with significantly reduced variation. Further, as for power of the output idler light depicted in FIG. 8BD, the waveform of the input signal light depicted in FIG. 8AA is maintained and exhibits the same variation.

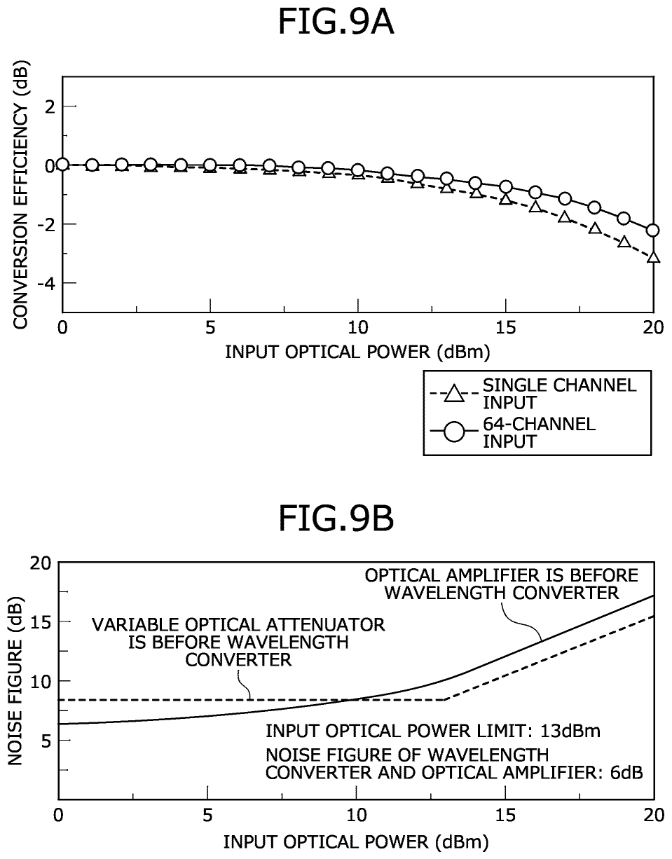

Examples of characteristics degradation with the conventional techniques are described. FIGS. 9A and 9B are graphs depicting examples of degradation of characteristics with the conventional techniques. FIG. 9A shows conversion efficiency with respect to the input optical power. In FIG. 9A, “Δ” (dashed-line curve) depicts optical power in an instance of single-channel input and “O” (solid-line curve) depicts optical power in an instance of multi-channel (64-channel) input. It has been observed that regardless of the number of channels, as the power of the input signal light increases, the conversion efficiency (output optical power of converted signal) decreases, and signal degradation in the wavelength conversion becomes significant from a saturation amount of about 1 dB and higher.

With the conventional techniques, for example, when input signal light with optical power of 18 dBm is wavelength converted, the amount of saturation of the conversion efficiency is about 2 dB and thus, signal degradation in the wavelength conversion is significant. To suppress this signal degradation in the wavelength conversion, for example, the input optical power has to be lowered to no more than about 13 dBm for which the amount of saturation of the conversion efficiency is 0.5 dB. With the conventional techniques, when the input power to the wavelength converter 606 is limited, a corresponding amount has to be compensated at the downstream optical amplifier 607 to suppress increases in overall linear noise of the nodes including wavelength conversion.

FIG. 9B shows noise figure with respect to the input optical power. With the configuration according to the conventional techniques (FIG. 6), the conversion efficiency was assumed to be 0 dB and noise figures of the wavelength converter 606 and the optical amplifier 605 were assumed to be 6 dB while the input optical power to the wavelength converter 606 was limited to be not more than 13 dBm and variation of the noise figure due to the power of the input signal light was calculated.

In FIG. 9B, a dotted-line characteristics curve is an instance in which a variable optical attenuator is upstream to the wavelength converter 606 while a solid-line characteristics curve is an instance in which the optical amplifier 605 is upstream to the wavelength converter 606. In general, with an input optical power of 18 dBm (in a case of 64-channel, 0 dBm/ch), when a variable optical attenuator is provided upstream (dotted-line characteristics curve), noise figure degradation is about 5 dB compared to low power region and when the optical amplifier is provided upstream (solid-line characteristics curve), noise figure degradation is about 9 dB compared to low power region. In contrast, by applying the embodiments, these degradations of 5 dB or 9 dB may be suppressed.

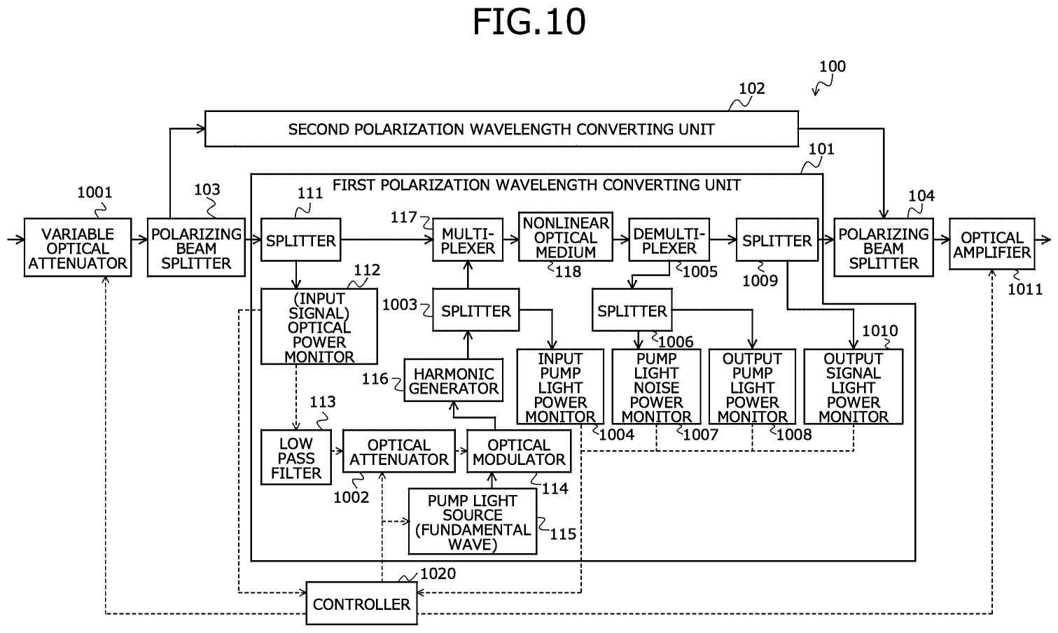

FIG. 10 is a diagram of a third example of the wavelength converting device. The third example is a detailed configuration of the general configuration described in the first example (FIG. 1) and includes the controller; components that are the same as those depicted in FIG. 1 are given the same reference numerals used in FIG. 1.

Input signal light is input to the polarizing beam splitter 103 via a variable optical attenuator 1001. The polarizing beam splitter 103 separates input signal light that has been polarization multiplexed, outputs one polarization component of the input signal light to the first polarization wavelength converting unit 101, and outputs the other polarization component of the input signal light to the second polarization wavelength converting unit 102.

In the first polarization wavelength converting unit 101, the splitter 111 splits and outputs the input signal light to the optical power monitor (input signal light power monitor) 112 and the multiplexer 117. The optical power monitor (input signal light power monitor) 112 monitors the optical power of the input signal light and outputs monitor values to a controller 1020. The low pass filter 113 outputs a low-frequency component of the modulation frequency in the detected input signal light (low-speed component with optical power that varies over time) to an optical attenuator 1002. The optical attenuator 1002 controls and attenuates the output of the low pass filter 113 by an amount based on the control of the controller 1020 and outputs the attenuated component to the optical modulator 114.

The pump light source 115, based on the control of the controller 1020, controls the output of a fundamental wave (for example, a communication wavelength of 1550 nm) corresponding to the fluctuation of the optical power of the input signal light and outputs the pump light to the optical modulator 114. The optical modulator 114 modulates the intensity of the input signal light by the output (pump light) from the pump light source 115. The harmonic generator 116 generates harmonics, for example, second-order harmonic pump light, obtained by multiplying the fundamental wave.

A splitter 1003 splits and outputs the output of the harmonic generator 116 to the multiplexer 117 and an input pump light power monitor 1004. The input pump light power monitor 1004 detects the pump light power and outputs the pump light power to the controller 1020.

The multiplexer 117 multiplexes the input signal light and optically modulated pump light and inputs the multiplexed light to the nonlinear optical medium 118. The nonlinear optical medium 118 generates wavelength converted light (converted light, idler light) from the input signal light by the nonlinear optical effect and Raman amplification.

A demultiplexer 1005 demultiplexes the wavelength converted light output by the nonlinear optical medium 118. Light of the pump light wavelength in the wavelength converted light is separated and output to a splitter 1006 and the wavelength converted light (output signal light) is separated and output to a splitter 1009.

The splitter 1006 splits and outputs the optical power of the pump light wavelength to a pump light noise power monitor 1007 and an output pump light power monitor 1008. The pump light noise power monitor 1007 detects the optical power of pump light noise and the output pump light power monitor 1008 detects the optical power of the output pump light, the detected optical powers being output to the controller 1020 by the pump light noise power monitor 1007 and the output pump light power monitor 1008.

The splitter 1009 splits and outputs the wavelength converted light (output signal light) to an output signal light power monitor 1010 and the polarizing beam splitter 104. The output signal light power monitor 1010 detects and outputs the optical power of the wavelength converted light (output signal light) to the controller 1020.

The polarizing beam splitter 104 combines the polarization component output by the first polarization wavelength converting unit 101 and the polarization component output by the second polarization wavelength converting unit 102 and outputs the combined components to an optical amplifier 1011. The optical amplifier 1011, under the control of the controller 1020, optically amplifies the wavelength converted light (output signal light) output by the polarizing beam splitter 104.

The controller 1020, based on the detection output of each of the monitors (power of the input signal light, power of the input pump light, power of the pump light noise, power of the output pump light, power of the output signal light), controls the amount of attenuation by the optical attenuator 1002 and the power of the pump light output from the (fundamental wave) pump light source 115. The controller 1020 further controls the amount of optical amplification by the optical amplifier 1011.

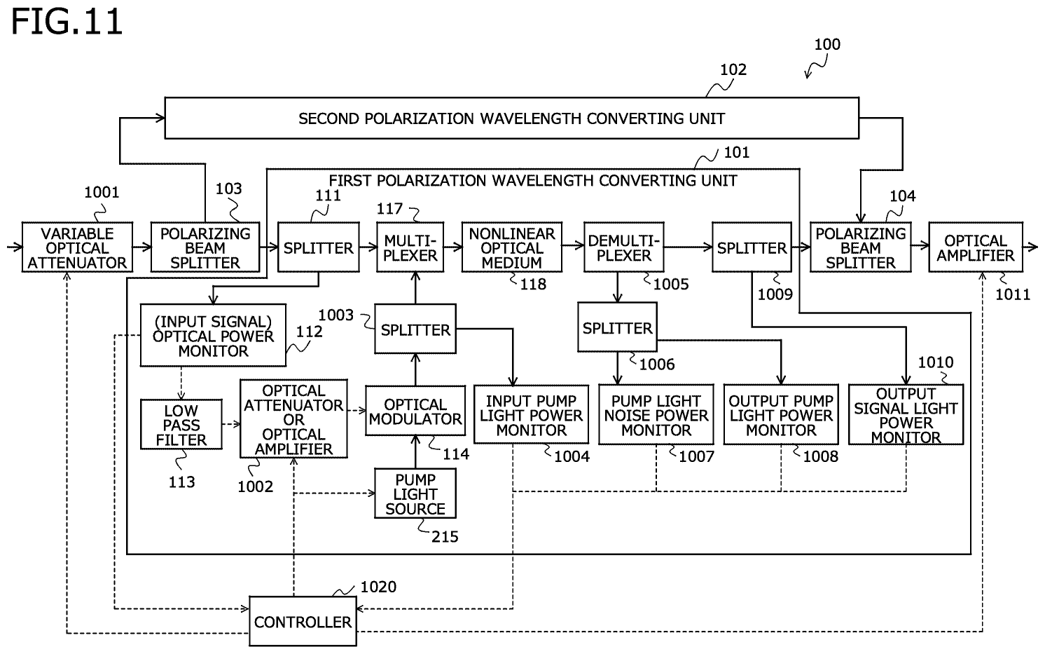

FIG. 11 is a diagram of a fourth example of the wavelength converting device. The fourth example is a detailed configuration of the general configuration described in the second example (FIG. 2) and includes the controller; components that are the same as those depicted in FIGS. 1 and 2 are given the same reference numerals used in FIGS. 1 and 2.

In the fourth example, the optical attenuator 1002 downstream from the low pass filter 113 may be an optical amplifier. In the fourth example, similar to the second example (FIG. 2), the pump light source 215 is a second-harmonic pump light source of a fundamental wave and the harmonic generator 116 is omitted. Further, the nonlinear optical medium 118 is a second-order nonlinear optical medium. Further, the pump light source 215 may be a fundamental-wave pump light source and the nonlinear optical medium 118 may be a third-order nonlinear optical medium.

Similar to the third example, the controller 1020, based on the detection output of each of the monitors (power of the input signal light, power of the input pump light, power of the pump light noise, power of the output pump light, power of the output signal light), controls the amount of attenuation of the optical attenuator 1002 (or amount of amplification of the optical amplifier). The controller 1020 further controls the power of the pump light output by the pump light source 215 and the amount of optical amplification by the optical amplifier 1011.

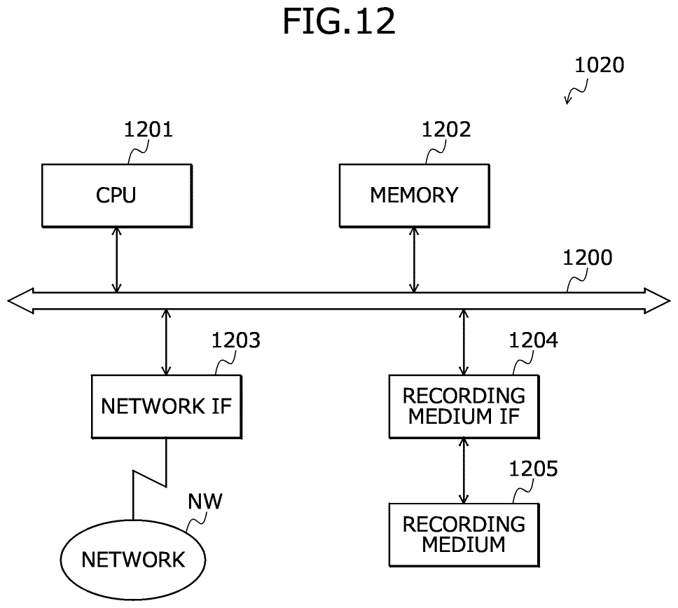

An example of configuration of the controller is described. FIG. 12 is a diagram depicting an example of a hardware configuration of the controller of the wavelength converting device. FIG. 12 depicts an example of the configuration of the controller 1020, which corresponds to the controller of the wavelength converting devices depicted in FIGS. 10 and 11.

In the example of the configuration depicted in FIG. 12, the controller 1020 has a processor 1201 such as a central processing unit (CPU), a memory 1202, a network interface (IF) 1203, a recording medium IF 1204, and a recording medium 1205. Further, the components are connected by a bus 1200.

Here, the processor 1201 is the controller, which governs overall control of the wavelength converting device 100. The processor 1201 may have multiple cores. The memory 1202 includes, for example, a read-only memory (ROM), a random-access memory (RAM), and a flash ROM, etc. In particular, for example, the flash ROM stores control programs; the ROM stores application programs; and the RAM is used as a work area of the processor 1201. Programs stored in the memory 1202 are loaded onto the processor 1201, whereby encoded processes are executed by the processor 1201.

The network IF 1203 administers an interface between a network NW and the controller (the controller 1020) and controls the input and output of information between the wavelength converting device 100 and an external device.

The recording medium IF 1204, under the control of the processor 1201, controls the reading and writing of data with respect to the recording medium 1205. The recording medium 1205 records data written thereto under the control of the recording medium IF 1204.

The controller (the controller 1020) may be connectable to, for example, an input apparatus, a display, etc. via an IF, in addition to the components above.

The processor 1201 depicted in FIG. 12 may implement functions of the wavelength converting device 100 by executing programs. The controller 1020 may be configured by a field-programmable gate array (FPGA) or an application specific integrated circuit (ASIC). The processor 1201 may be further configured by a digital signal processor (DSP) or the like.

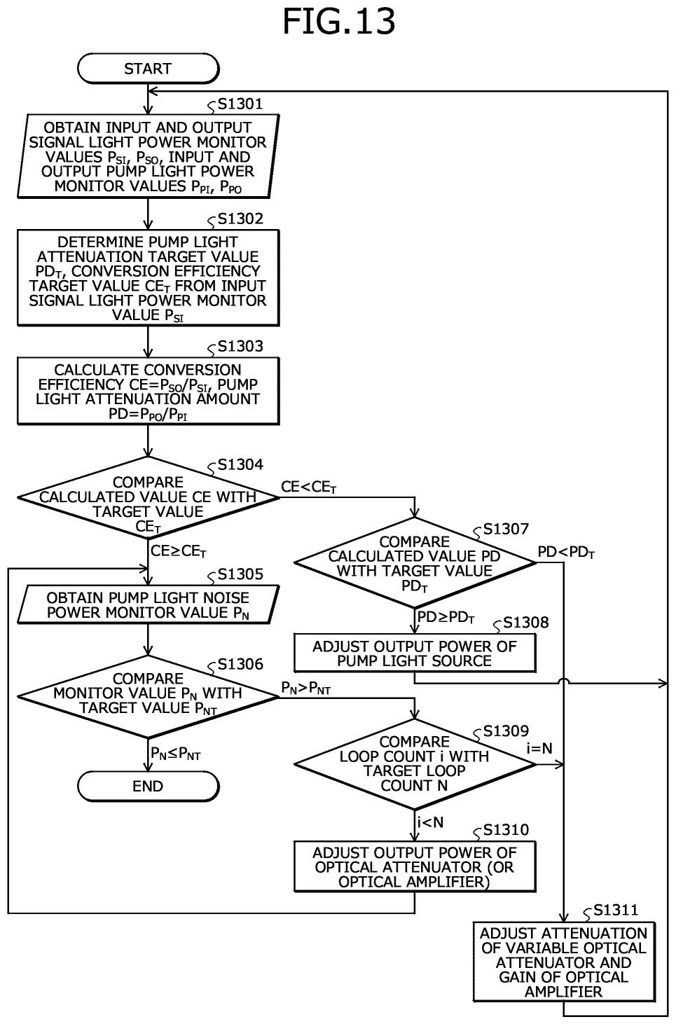

FIG. 13 is a flowchart depicting detailed control of the wavelength converting device. Control details common to the third example (FIG. 10) and the fourth example (FIG. 11) are described with reference to FIG. 13. The control depicted in FIG. 13 is a process of the controller (the controller 1020) of the wavelength converting device 100; the controller starts the process at the initial setting of the wavelength converting device 100 or when the monitor values fluctuate.

First, the controller obtains an input signal light power monitor value P_{SI} detected by the optical power monitor 112 and an output signal light power monitor value P_{SO} detected by the output signal light power monitor 1010. Further, the controller obtains an input pump light power monitor value P_{PI} detected by the input pump light power monitor 1004 and an output pump light power monitor value P_{PO} detected by the output pump light power monitor 1008 (step S1301).

Next, the controller determines a pump light attenuation target value PD_{T} and a predetermined conversion efficiency target value CE_{T} from the input signal light power monitor value P_{SI} (step S1302). Next, the controller calculates conversion efficiency CE=P_{SO} /P_{SI} and a pump light attenuation amount PD=P_{PO}/P_{PI} (step S1303).

Next, the controller compares the calculated conversion efficiency CE with the conversion efficiency target value CE_{T} (step S1304). As a result of the comparison, when the conversion efficiency CE is at least equal to the conversion efficiency target value CE_{T} (step S1304: CE>CE_{T}), the controller transitions to the process at step S1305. On the other hand, when the conversion efficiency CE is less than the conversion efficiency target value CE_{T} (step S1304: CE<CE_{T}), the controller transitions to the process at step S1307.

At step S1305, the controller obtains a pump light noise power monitor value P_{N} detected by the pump light noise power monitor 1007 (step S1305). Next, the controller compares the pump light noise power monitor value P_{N} with a pump light noise target value P_{NT} (step S1306). As a result of the comparison, when the pump light noise power monitor value P_{N} is not more than the pump light noise target value P_{NT} (step S1306: P_{N}≤P_{NT}), the controller terminates the processes above. On the other hand, when the pump light noise power monitor value P_{N} exceeds the pump light noise target value P_{NT} (step S1306: P_{N}>P_{NT}), the controller transitions to the process at step S1309.

At step S1307, the controller compares the calculated pump light attenuation amount PD with the pump light attenuation target value PD_{T} (step S1307). As a result of the comparison, when the pump light attenuation amount PD is at least equal to the pump light attenuation target value PD_{T} (step S1307: PD≥PD_{T}), the controller adjusts the output power of the pump light source 115 (step S1308) and returns to the process at step S1301. On the other hand, when the pump light attenuation amount PD is less than the pump light attenuation target value PD_{T} (step S1307: PD<PD_{T}), the controller performs a process of adjusting the attenuation amount of the variable optical attenuator 1001 and gain of the optical amplifier 1011 (step S1311). Thereafter, the controller returns to the process at step S1301.

At step S1309, the controller compares a loop count i of the number of executions of the processes with a predetermined target loop count N (step S1309). As a result of the comparison, when the loop count i is less than the target loop count N (step S1309:i<N), the controller adjusts the output power of the optical attenuator (or optical amplifier) 1002 (step S1310) and returns to the process at step S1305. In this loop process, the output power of the optical attenuator (or optical amplifier) 1002 is adjusted so that the pump light noise power monitor value P_{N} is not more than the pump light noise target value P_{NT}. On the other hand, when the loop count i reaches the target loop count N (step S1309:i=N), the controller transitions to the process at step S1311.

The wavelength converting device of the embodiments described above includes the optical power monitor that monitors fluctuation of the optical power of the input signal light; the pump light source; the optical modulator that modulates the intensity of the pump light output by the pump light source; the multiplexer that multiplexes the intensity-modulated pump light and signal light; the nonlinear optical medium that uses the nonlinear optical effect and generates wavelength converted light of the signal light output by the multiplexer; and the controller. The optical power monitor detects and notifies the controller of fluctuations in the optical power of the input signal light; and based on the fluctuations, the controller performs control including varying and outputting the optical power of the pump light of the pump light source to the optical modulator. For example, the controller similarly controls the output of the pump light source to increase or decrease corresponding to increases and decreases (fluctuations) in the optical power of the input signal light. As a result, response to fluctuations in the optical power of the input signal light is enabled, saturation of the conversion efficiency of wavelength conversion is suppressed, and degradation of signal quality and nonlinear noise may be suppressed.

Further, the wavelength converting device includes the low pass filter that transmits low-frequency components of the input signal light, and the optical modulator may be configured to control the frequency band of the intensity modulation to be lower than the modulation rate of the signal light. As a result, the frequency band of the intensity modulation is controlled to be lower than the modulation rate of the input signal light, saturation of the conversion efficiency is suppressed, and degradation of signal quality and nonlinear noise may be suppressed.

The wavelength converting device may further include optical power monitors that respectively detect the output power of the wavelength converted light and the optical power of the input and output pump light, a variable optical attenuator capable of varying the optical power of the signal light input to the device, and an optical amplifier that optically amplifies the wavelength converted light output by the device. The controller calculates the conversion efficiency of the wavelength signal light based on the optical power of the input signal light and the optical power of the output signal light, calculates the amount of attenuation of the pump light by the power of the input and output pump light, and adjusts the optical power of the pump light or adjusts the amount of attenuation by the variable optical attenuator and gain of the optical amplifier so that a predetermined target conversion efficiency is achieved. As a result, pump light power for wavelength conversion may be suitably adjusted and the conversion efficiency of wavelength conversion may be improved.

The wavelength converting device may further include an optical power monitor that detects the power of pump light noise from the output of the nonlinear optical medium, and an optical attenuator that attenuates the optical power of the signal light input to the optical modulator. The controller may adjust the amount of attenuation by the optical attenuator so that the power of the noise of the pump light becomes a predetermined target value. As a result, the power of the noise of the wavelength converted light is reduced and a suitable output power may be obtained.

Further, in the wavelength converting device, the nonlinear optical medium may be a second-order nonlinear optical medium; and the pump light source may output fundamental-wave pump light of a communication wavelength and output modulation output of the optical modulator to a multiplexer via a second-order harmonic generator that generates second-order harmonics. Further, in the wavelength converting device, the nonlinear optical medium may be a second-order nonlinear optical medium, and the pump light source may output second-order harmonic pump light of a fundamental wave, which is a communication wavelength. Further, in the wavelength converting device, the nonlinear optical medium may be a third-order nonlinear optical medium, and the pump light source may output fundamental-wave pump light of a communication wavelength. As described, wavelength conversion may be performed using a pump light source according to the type of the nonlinear optical medium.

Further, in the wavelength converting device, a polarizing beam splitter for separating polarization components of the signal light input to the device and a polarizing beam splitter for combining wavelength converted light output by the device may each be provided. As a result, wavelength conversion may be suitably performed for each polarization component of the polarization multiplexed signal light.

The embodiments of the present invention achieve an effect in that increases of nonlinear distortion occurring with wavelength conversion are suppressed while degradation of signal quality is suppressed and transmission capacity is increased.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wavelength converting device, comprising:
an optical power monitor that monitors fluctuation of optical power of signal light input to the wavelength converting device;
a pump light source that outputs pump light;
an optical modulator that performs intensity modulation which includes modulating an intensity of the pump light output by the pump light source;
a multiplexer that multiplexes the intensity-modulated pump light and the signal light;
a nonlinear optical medium that, using a nonlinear optical effect, generates wavelength converted light of the signal light output by the multiplexer; and
a controller configured to vary and output to the optical modulator, optical power of the pump light of the pump light source, the controller varying the optical power of the pump light based on the fluctuation detected by the optical power monitor.

2. The wavelength converting device according to claim 1, wherein the controller receives output regarding the fluctuation from the optical power monitor and performs control to similarly increase or decrease output of the pump light source corresponding to an increase or decrease of the optical power of the input signal light indicated by the output from the optical power monitor.

3. The wavelength converting device according to claim 1, further comprising a low pass filter that passes a low-frequency component of the input signal light and outputs the low-frequency component to the optical modulator, wherein
the optical modulator limits a frequency band of the intensity modulation to be lower than a modulation rate of the signal light.

4. The wavelength converting device according to claim 1, further comprising:
a plurality of optical power monitors respectively detecting power of the wavelength converted light output, power of the pump light input, and power of the pump light output;
a variable optical attenuator that varies the optical power of the signal light input to the device; and
an optical amplifier that optically amplifies the wavelength converted light output by the device, wherein
the controller:
calculates a conversion efficiency of wavelength conversion of the signal light, based on the optical power of the signal light input to the device and the optical signal power of the signal light output by the device,
calculates an attenuation amount of the pump light from the power of the pump light input and the power of the pump light output, and
adjusts an attenuation amount of the variable optical attenuator and a gain of the optical amplifier or adjusts the optical power of the pump light so that the conversion efficiency is a predetermined target conversion efficiency.

5. The wavelength converting device according to claim 1, further comprising:
an optical power monitor that detects power of noise of the pump light from an output of the nonlinear optical medium; and
an optical attenuator that attenuates the optical power of the signal light input to the optical modulator, wherein
the controller adjusts the attenuation amount of the optical attenuator so that the power of the noise of the pump light becomes a predetermined target power.

6. The wavelength converting device according to claim 1, wherein
the nonlinear optical medium is a second-order nonlinear optical medium,
the pump light source outputs fundamental-wave pump light of a communication wavelength, and
modulated output of the optical modulator is output to the multiplexer via a second-order harmonic generator that generates a second-order harmonic.

7. The wavelength converting device according to claim 1, wherein
the nonlinear optical medium is a second-order nonlinear optical medium, and
the pump light source outputs second-order harmonic pump light of a fundamental wave of a communication wavelength.

8. The wavelength converting device according to claim 1, wherein
the nonlinear optical medium is a third-order nonlinear optical medium, and
the pump light source outputs fundamental-wave pump light of a communication wavelength.

9. The wavelength converting device according to claim 1, further comprising a plurality of polarizing beam splitters respectively separating a polarization component of the signal light input to the device and combining the polarization component with the wavelength converted light output by the device.

10. A wavelength converting method for controlling a wavelength converting device including: an optical power monitor that monitors fluctuation of optical power of signal light input to the wavelength converting device; a pump light source that outputs pump light; an optical modulator that performs intensity modulation which includes modulating an intensity of the pump light output by the pump light source; a multiplexer that multiplexes the intensity-modulated pump light and the signal light; a nonlinear optical medium that, using a nonlinear optical effect, generates wavelength converted light of the signal light output by the multiplexer; and a controller, the method being executed by the controller and comprising:
varying and outputting to the optical modulator, optical power of the pump light of the pump light source, the optical power of the pump light being varied based on the fluctuation detected by the optical power monitor.
